(19) United States
(12) Patent Application Publication
(10) Pub. No.: US 2026/0061769 A1
(43) Pub. Date: Mar. 5, 2026

(54) SECURITY ELEMENT WITH COLOUR-PRODUCING NANOSTRUCTURES AND PRODUCTION METHOD THEREFOR

(71) Applicant: GIESECKE+DEVRIENT CURRENCY TECHNOLOGY GMBH, Muenchen (DE)

(72) Inventors: Moritz HOEFER, Muenchen (DE); Christian STOECKL, Muenchen (DE)

(21) Appl. No.: 19/108,203

(22) PCT Filed: Sep. 4, 2023
(86) PCT No.: PCT/EP2023/074189

§ 371 Date: Mar. 3, 2025

(30) Foreign Application Priority Data
Sep. 2, 2022 (DE) 10 2022 003 230.9

(51) Int. Cl. B42D 25/324; B42D 25/29; B42D 25/405

(52) U.S. Cl. CPC B42D 25/324; B42D 25/29; B42D 25/405

(57) ABSTRACT

A security element includes a structured layer with a base surface, recesses or protrusions that are recessed or elevated relative to the base surface, and a reflector layer arranged on the structured layer. The recesses or protrusions are designed as color-generating nanostructures based on their dimensions along the base surface, their vertical extension perpendicular to the base surface, and their arrangement on the base surface, which are formed as color-generating nanostructures. The structured layer includes areas in which the vertical extension of the recesses or protrusions varies along a direction according to a function that does not have a constant value so that a mixed color is visible in each of the areas in the top view.

The invention relates to a security element with color-generating nanostructures, which comprises: a structured layer that has a base surface and lowered recesses or raised protrusions that are lowered or elevated relative to the base surface, and a reflector layer arranged on the structured layer, wherein the protrusions or recesses are formed as color-generating nanostructures with respect to their dimensions along the base surface, their vertical dimension perpendicular to the base surface and their arrangement on the base surface, and wherein the structured layer comprises a plurality of areas that provide a colored motif or image, with the areas preferably forming pixels.

The invention further relates to a method for producing a security element, wherein the method comprises: creating a structured layer that comprises a base surface and lowered recesses or elevated protrusions that are lowered or elevated relative to the base surface, and arranging a reflector layer on the structured layer, wherein the protrusions or recesses are configured as color-generating nanostructures with respect to their dimensions along the base surface, their vertical dimension perpendicular to the base surface and their arrangement on the base surface, and wherein the structured layer is formed with a plurality of areas that provide a colored motif or image, with the areas preferably forming pixels.

Such a security element and such a method of manufacturing are known from DE 102012105571 A1.

Nanostructures with dimensions in the sub-wavelength range are known in the prior art, which allow colored representations to be realized. To do this, protrusions or recesses are arranged on a surface. If this structure is mirror-coated, the color depends on the structural parameters of the protrusions/recesses when these are formed as nanostructures, i.e. structures with dimensions below the wavelength of visible light. Such structures are also known, for example, from DE 2009056934 A1, DE 102010048262 A1, DE 102010049832 A1, US 2012/236415 A1, WO 2019/140572 A1 or WO 2019/1804 60 A1. EP 3572852 A1 also discloses a security element with protrusions/depressions that realize a color-generating nanostructure.

It is known to provide the color-producing nanostructures in areas that constitute pixels or subpixels. In each pixel or subpixel, a predetermined configuration of the protrusions or recesses is to be provided with regard to the dimensions along the base area, the vertical dimension perpendicular to the base surface and the arrangement on the base surface—depending on the color that the pixel or subpixel is configured to produce. Such nanostructures produce a color that is usually influenced by the vertical extension. In the prior art, it is known to use uniform vertical extensions in the pixels or subpixels, i.e. a uniform height in the case of protrusions or a uniform depth in the case of recesses. In the case of subpixels, for example, the aforementioned DE 102012105571 A1 (FIGS. 14b and 14c) provides for interleaving the subpixels that differ in terms of the heights/depths of the protrusions/recesses in order to set a color by combining several, e.g. RGB subpixels. The formation of areas with individual vertical extensions that differ from area to area thus allows the generation of a colored image, for which the areas are implemented in the form of subpixels. The subpixels each generate a color (e.g. red, green or blue) and together set the desired color of the pixel.

On this basis, the invention is based on the task of specifying a security element based on color-generating nanostructures that has an improved color effect and, in particular, does not require sub-pixels.

The invention is defined in the independent claims. The dependent claims relate to preferred embodiments.

The security element comprises a structured layer that has a base surface and, in relief relative to the latter, recessed concave indentations or elevated convex protrusions. Any mention of recesses below is intended only as an example. A reflector layer is arranged on the structured layer. The protrusions or recesses are designed as color-generating nanostructures with regard to their structural parameters, in particular their dimensions along the base surface, their vertical extension perpendicular to the base surface and their arrangement on the base surface, as is known from the prior art and in particular from the already mentioned EP 3572852 A1. The vertical extension is the height of the protrusions or the depth of the recesses. The protrusions or recesses may have top surfaces that are parallel to the base surface or to a tangent to the base surface. The term “nanostructures” refers to the vertical extensions of the protrusions/recesses, which are usually below 500 nm. The dimensions along the base surface and the distances between adjacent protrusions/recesses, on the other hand, are usually in the range of micrometers.

The nanostructure produces a colored motif or image and comprises several areas, with the vertical extension of the protrusions or recesses varying in each area along a direction according to a function that does not have a constant value. This results in a color in each of these areas when viewed from above, which is produced as a mixed color as a result of the variation in the vertical extension. The term “mixed color” expresses that the color is generated by the mixture of the effect of the vertical extensions of the protrusions or recesses, which vary in size in the area. The term “mixed color” is to be distinguished from a color mixture, as it is caused by several subpixels or pixels, because there the nanostructure in each area, i.e. subpixels or pixels, produces exactly one single color due to the non-varying extension of the protrusions or recesses without a mixing effect, and only several pixels/subpixels together mix their single colors. Due to the intended variation of the vertical extensions of the protrusions or recesses within an area (e.g. pixel), the color of each area is created by a mixing effect and not as a single color.

This simplifies the generation of an image, since no structuring in sub-pixels is necessary for the generation of color; rather, each area, for example each pixel, can provide a mixed color. This color is set in the respective area by varying the vertical extension, in particular the area over which the variation occurs and the distribution of the vertical extensions in this area, as well as the mean vertical extension, i.e. the mean value of the distribution.

The colors that contribute to the mixture are set, among other factors, by the degree of variation in the vertical extension. If the vertical extension varies over a large range, more colors are combined into the mixed color than if the vertical extension varies over a smaller range. The mean depth of the varied vertical extension corresponds to a color that has a hue-equivalent wavelength that is also in the middle of the hue-equivalent wavelengths of all the colors that are combined to form the mixed color. It is therefore preferred that for each area the center of the hue-equivalent wavelengths of the (mixed) color that the area produces is set by the mean depth of the varied vertical extension.

To create a colored image, it is particularly preferred that the areas, at least some of these areas, differ in terms of function. The difference can lie in a range of variations in the vertical extensions. The difference can also lie in how the various vertical extensions are distributed in the varied area, for example, whether large vertical extensions occur more frequently than small vertical extensions. This then sets the center of distribution of the hue-equivalent wavelengths of the mixed color asymmetrical within the range covered by all hue-equivalent wavelengths of the mixed color. It is therefore preferable to combine different ranges that differ in terms of the range of vertical extensions and/or the distribution of different vertical extensions in the varied range.

Furthermore, optionally, in particular in the latter case, the distribution of the vertical extensions is not symmetrical about the center of the covered range of variation of the vertical extensions.

Particularly good color mixing is obtained when the vertical extension of the protrusions or recesses increases or decreases along the direction according to a gradient. In this way, hue-equivalent wavelengths spread over a range are combined, with all hue-equivalent wavelengths contributing equally to the mixed color if the gradient is a linear gradient. Individual hue-equivalent wavelengths can contribute with different impact to the mixed color, if the gradient is non-linear, for example quadratic, etc.

A particularly preferred embodiment is obtained when these nanostructures are combined with microstructures, i.e. with microstructure elements that have dimensions in at least one direction that are above the wavelengths of the visible spectral range, e.g. at least 5 μm, preferably 10 μm, 50 μm or more. Then it is possible to form the areas in each case as microstructure elements equipped with a height profile (i.e. a variation in height), e.g. inclined mirror surfaces. At least some of the areas differ from one another in terms of the height profile and/or the shape of the microstructure elements (in a top view of the base plane). The nanostructures are formed on the microstructure elements, the vertical extension of which varies across the respective microstructure element. In this embodiment, an area then corresponds to a microstructure element.

It is particularly preferred that the vertical extension increases or decreases with the height of the microstructure element, e.g. the mirror surface, since then a particularly simple production is achieved, which exploits local differences in the sensitivity of a photoresist that occur due to the microstructure. There are then either protrusions/recesses with a greater vertical extension at the upper edge of the mirror and protrusions/recesses with a smaller vertical extension at the lower edge of the mirror, or the other way around. Between the upper edge and the lower edge of the mirror, the decrease in vertical extension runs parallel to the inclination of the mirror.

The microstructure elements, e.g. the mirror surfaces, can be formed in such a way that they produce a bulging effect, which is intensified by the color-imparting nanostructures and is colored, i.e. produces an improved 3D effect.

The direction along which the nanostructures vary with respect to the vertical extension is preferably aligned at a certain angle to the gradient of the height profile, preferably following this gradient. This can be used as an additional covert security feature, as it is not visible to the naked eye but can be detected by a machine-based analysis of the security element.

Furthermore, in this context it is possible to make the range of variation of the vertical extension dependent on a inclination angle of the mirror surface. This can be done at a uniform or varied mirror length along the gradient of the mirror surface.

The nanostructures can be described by the following parameters:

The protrusions/recesses can be arranged in a regular or irregular pattern, which means a quasi-statistical distribution of the protrusions/recesses on the base surface. In the case of a regular arrangement, the lattice structure used is a relevant parameter, for example square base lattice, hexagonal base lattice, etc.

The distance between the structures, i.e. the protrusions/recesses, affects the color effect. In the case of irregularly arranged protrusions/recesses, this applies to the mean distance and/or the area coverage that the protrusions/recesses have on the base surface compared to the remaining areas of the base surface.

The lateral dimensions of the protrusions/recesses further characterize the embossed layer. The protrusions/recesses can be rotationally symmetrical in top view, but can also be formed to extend along a direction. This direction can be uniform, but it can also vary. The vertical extensions of the protrusions or recesses perpendicular to the base surface is another parameter that particularly affects the color produced.

The basic shape of the protrusions/recesses, i.e. the appearance in top view, characterizes the embossed structure just as much as the flank shape, i.e. the profile of the protrusions/recesses in a cross-section perpendicular to the base surface. In top view, square, hexagonal, circular, elliptical, rectangular, etc. basic shapes can be used. In the sectional view, the profile can take the form of a sine wave, a parabola, a rectangular structure with almost vertical sides, etc.

The areas may preferably be pixels of a displayed image or motif. Preferably, the areas form pixels that are preferably arranged in a regular pattern (e.g. square or hexagonal lattice) and generate the colored motif. This applies to all further versions or options described here.

After being provided with the reflector layer, the nanostructures can be overcoated with a dielectric material. The dielectric material covers the recesses/elevations that are preferably formed in an embossed lacquer layer. The refractive index of the dielectric material is preferably identical to that of the embossed lacquer layer, but can also be different.

The invention will be explained in more detail below with reference to the attached drawings, which also disclose features essential to the invention. These examples are for illustration purposes only and should not be interpreted as restrictive. For example, a description of an embodiment comprising a plurality of elements or components does not imply that all of those elements or components are necessary to implement the invention. Rather, other embodiments may utilize different elements and components, fewer elements or components, or additional elements or components. Elements or components of various embodiments may be combined with one another unless otherwise indicated. Modifications and variations described for one of the embodiments may also be applicable to other embodiments. To avoid repetition, identical or corresponding elements in different figures are designated by the same reference signs and are not explained more than once. The figures show:

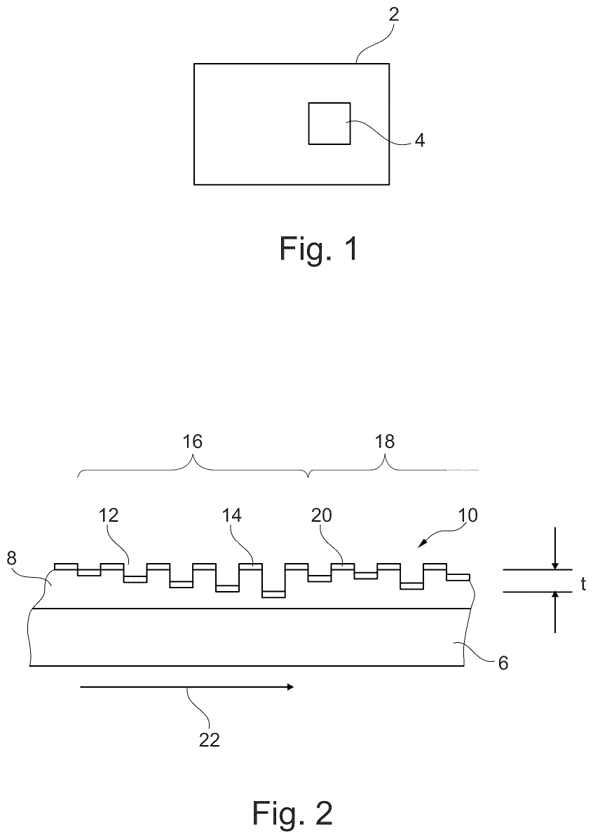

FIG. 1 a banknote with a security element,

FIG. 2 a cross-section through the security element of FIG. 1, in a first embodiment,

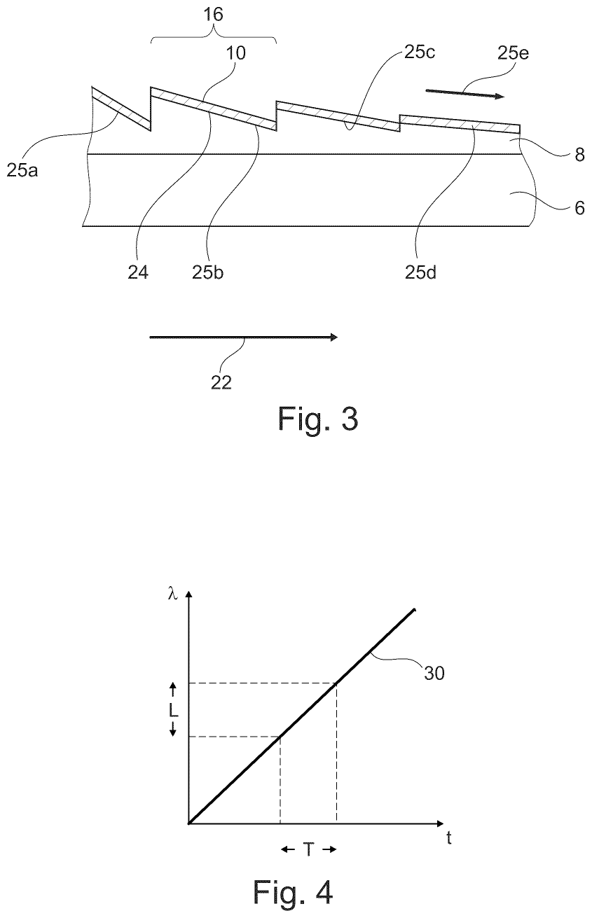

FIG. 3 a similar cross-section for a second embodiment,

FIG. 4 a diagram explaining the principle of operation of the embodiments,

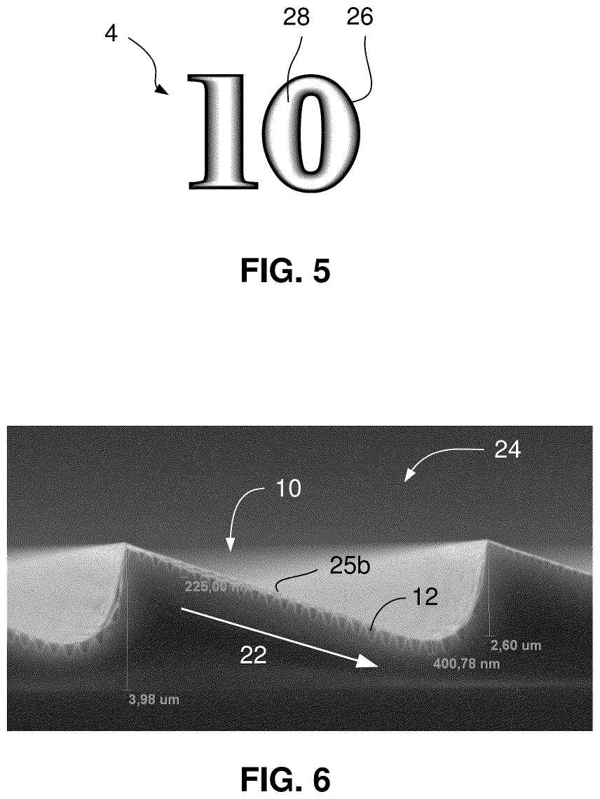

FIG. 5 a top view of the security element of the second embodiment and

FIG. 6 a SEM image of this security element.

FIG. 1 shows in top view a security document, in this case a banknote 2, which comprises a security element 4 that is intended to protect against counterfeiting of the security document. The security element 4 displays a colored image in top view. For this purpose, it has a structured surface, which can be seen in the sectional view of FIG. 2.

The security element is constructed on a substrate 6, on which there is an embossed lacquer layer 8, in which a nanostructure 10 is embossed. A preferred alternative to embossing will be explained later.

The nanostructure 10 comprises a multiplicity of recesses 12 and is provided with a reflector layer 14. Such nanostructures are in principle known to a skilled person. They produce a color when viewed from above.

The security element comprises at least two areas 16, 18 that differ in terms of the nanostructure 10, namely with regard to the vertical extension of the recesses 12 relative to a base surface 20, relative to which the recesses 12 are recessed.

In the area 16, the vertical extension, i.e. the depth t of the recesses 12, increases along a direction 22. In the area 18, the depth t varies along the direction 22 according to another function, namely a roughly sinusoidal function.

The depth t of each recess 12 influences the color effect that appears when viewed from above. Since 16 different depths are arranged along direction 22, a mixed color is created, as will be explained below with reference to FIG. 4. Since a different function is used in area 18, a different mixed color is created.

The mixed color between the areas 16 and 18 also differs in the embodiment because the depth ranges are different. In the area 18, the recesses 12 are significantly shallower than in the area 16. Therefore, a mixed color 18 is created, which is composed of other hue-equivalent wavelengths than in the area 16, in which deeper recesses 12 are used.

FIG. 2 shows, completely as example only, the formation of the nanostructure 10 with recesses that are lowered in relation to the base surface 20 (based on the representation of FIG. 2). Equally possible is a design in which elevations are arranged. As a vertical extension, the height of these elevations is then varied, of course.

A gradient is particularly preferred for the variation of the vertical extension along direction 22. Such a gradient allows a continuous mixture from colors that are close to one another in the color space. The type mixing of the individual hue-equivalent wavelengths can be set through the configuration of the gradient, which is e.g. linear or quadratic. Similarly, the distance between the recesses 12 or elevations can also be varied. This also influences the color that is created.

A particularly favorable combination using the nanostructure 10 is obtained when combining nanostructure with a microstructure 24. This is shown schematically in FIG. 3. Here, the microstructure 24 is shown as a sequence of obliquely positioned micro-mirrors 25a-25d, where the individual micro-mirrors 25a-25d differ in their inclination with respect to a base plane, which can be defined, for example, as the surface of the substrate 6 or is a plane parallel thereto. The nanostructure 10 is formed on each micro-mirror 25a-25d, which represents a microstructure element, and is then in turn covered with the reflector layer 14. FIG. 6 shows a SEM image of the microstructure 24.

This results in a combination of the effects produced by the microstructure 24 and the coloring in each individual microstructure element. In this way, for example, a bulging effect generated by microstructure 24 can be additionally supplemented by a color effect that goes beyond a uniform coloring, because the individual microstructure elements can produce an individual mixed color depending on how the function is selected along direction 22.

This function is preferably a gradient that is designed to follow the shape of the microstructure, i.e. the gradient direction 22 corresponds to a surface course of the microstructure 24, for example the inclination direction of the micro-mirrors 25a-25d. In the illustration of FIG. 3, the direction 22 thus corresponds to FIG. 2 and the sectional view of FIG. 3 shows the section plane in which the gradient of the mirror inclination lies. It is schematically indicated with 25e. FIG. 3 shows the simplified case in which all micro-mirrors 25a-25d have a gradient 25e in the same direction, i.e. they are all inclined in the same direction. This is, of course, not mandatory. Each microstructure element can have its own gradient direction. The direction 22 of the nanostructure 10 on the corresponding microstructure element is then aligned with this gradient direction, in particular in the same direction.

The registration of the inclination gradients of the microstructure elements, e.g. the gradient 25e of a micro-mirror 25d, can be used as a covert security element. Steep micro-mirrors, i.e. microstructure elements with a large height variation, then comprise a large gradient in the nanostructure, while microstructure elements with a low height variation have a lower variation in the height of the depressions or elevations. The following values can be used in examples:

| | mirror | mirror | mirror | | min. | max. |
|---|---|---|---|---|---|---|
| | inclination | length | height | | depth | depth |
| A | 20° (steep) | 10 μm | 3.5 | μm | 200 nm | 400 nm |
| B | 10° (shallow) | 10 μm | 1.75 | μm | 200 nm | 300 nm |

In variant A, this results in a depth variation T of 200 nm, while in variant B, the depth variation is only 100 nm.

To create a bulging effect, for example, the mirrors 25a to 25d can be arranged from a low slope for the micro-mirror 25d between, for example, 0 and 5°, to a large slope at the micro-mirror 25a of, for example, 30°. By means of the nanostructure 10, which for example produces a mixed color in the yellow range, in that the elevations or recesses are formed in a hexagonal arrangement and have a grating period of 280 nm, an edge length of a square cross-section of the recesses/elevations of 140 nm, and a minimum depth of 80 nm. The variation of the vertical extension of the recesses increases to a different degree, starting from the minimum depth of 80 nm, depending on the angle of inclination of the micro mirror. Thus, for example, steeper mirrors show darker shades of yellow, whereas the flatter mirrors provide lighter shades of yellow. This enhances the plasticity of the three-dimensional impression of the bulge effect.

This is illustrated in FIG. 5. Here the steep mirrors are located at the edge marked 26, whereas the flat mirrors are located in the center of the respective number marked 28. Similarly, a darker mixed color is located in the 26 area than in the 28 area. This results in the following values, for example:

| mirror inclination | mirror length | mirror height | | min. depth | max. depth | |
|---|---|---|---|---|---|---|
| 0° | 10 μm | 0 | μm | 80 nm | 80 | nm |
| 10° | 10 μm | 1.75 | μm | 80 nm | 120 | nm |
| 20° | 10 μm | 1.75 | μm | 80 nm | 160 | nm |

Of course, these conditions can also be reversed and a large gradient of depth variation can be used on flat mirrors and a small gradient on steep mirrors. This depends on the design, defining the mixed color to be created. Of course, the depth range can also be selected differently on the individual mirrors, so that the mixed color also differs more e.g. in terms of the hue-equivalent wavelengths which are combined.

FIGS. 3 and 6 show a microstructure 24 using the example of micro-mirrors 25a to 25d. Of course, other microstructures can also be used, for example with concave mirrors, Fresnel structures, lens structures, cushion structures, etc., whereby in each case the local gradient, i.e. the height profile, of the microstructure elements can also specify the direction of the gradient for the depth variation of the nanostructures.

Another advantage of arranging nanostructures 10 on microstructures 24 is that production fluctuations can be compensated. An error in embossing the nanostructures 10 can cause undesired local changes in their depth. Such changes are less noticeable when varying the depth and creating a mixed color, since the mixed color is not as strongly influenced by errors in the embossing of individual recesses/elevations.

The effect of depth variation is shown in FIG. 4. A curve 30 in FIG. 4 depicts the dependence of the wavelength k, which represents the chromatic tone or hue of the color, on the depth t of the depressions 12. A similar dependency also exists for the height of protrusions. If the depth is varied over a depth variation range T, a wavelength mixing L automatically results. FIG. 4 suggests a linear relationship for the sake of clarity. However, no axis scales are shown because the relationship is non-linear. Shallow structures do not automatically lead to shorter wavelengths. Experimental investigations show that with increasing structure depth, different colors or “colorfulness” are covered:

In example A, the color changes from flat to deep structures, i.e. with increasing structure depth, from pale yellow to rich yellow to gold.

In example B, the color changes from flat to deep structures, i.e. with increasing structure depth, from orange to magenta to violet and blue to green.

Security element 4 can, as mentioned, be produced by embossing. Alternatively, it can be produced by photolithography, which exploits the local differences in sensitivity of a photoresist that occur due to structuring the microstructure.

To achieve the different vertical extensions of the recesses and elevations of the nanostructures, advantage is taken of the fact that the exposure for the microstructure has already been carried out. This automatically prevents all recesses of nanostructure 10 from being formed with the same vertical extension. When the photoresist was exposed to the microstructure, a light dose gradient (corresponding to the height profile of the microstructure elements) was already deposited in the photoresist. Relatively little dose was placed at the upper edge of each mirror, while more dose was introduced into the resist at the lowest points of the mirror to achieve the mirror inclination. The photoresist is therefore increasingly bleached out from the upper edge of the mirror; the bleaching increases towards the lowest points of the height profile. When the nanostructure is projected, the photoresist, which has already been bleached out to different degrees, therefore reacts differently to the same exposure dose, depending on how much dose was previously placed to create the microstructure. It is therefore possible to work with a uniform exposure dose for the recesses 12 of the nanostructure 10 and still obtain recesses 12 of different depths. The depth is proportional to the dose that has previously been placed to create the microstructure 24 and the depth is, thus, automatically registered to the height of the microstructure.

To vary the depth of the nanostructures in a different way, a dose wedge is used for the patterning of the nanostructures 10 to specifically vary their depth. This dose wedge must take into account the dose of the first exposure, i.e. the exposure carried out for the microstructure 24, as well as the shape and direction of the gradient to be realized for the gradient of the vertical extension.

As an alternative to a photolithographic realization, the embossing already mentioned on the basis of FIGS. 2 and 3 can be carried out in an embossed lacquer 8.

After applying the reflector layer 14, the nanostructures 10 are preferably overcoated with a dielectric material (not shown). The dielectric material covers the protrusions/recesses, so that the nanostructure 10 is completely or partially evened out. This increases the durability and resistance to soiling of the security element. In addition, the color effect can be further adjusted because the refractive index of the dielectric material affects the color. The refractive index of the dielectric material is preferably identical to that of the layer in which the nanostructures 10 are formed, e.g. the layer of embossed lacquer 8, but can also be different. In the case of nanostructures 10 which are located (as in FIG. 2) on a flat base structure, the overcoating with the dielectric material can be carried out by applying and doctoring off excess material. In the case of nanostructures 10 which are formed on oblique mirrors (as in FIG. 4), a deposition process can be used to apply the dielectric material.

### LIST OF REFERENCE SIGNS

2 banknote
4 security element
6 substrate
8 embossed varnish layer
10 nanostructure
12 recess
14 reflector layer
16, 18 area
20 base surface
22 direction
24 microstructure
25a-d micro-mirrors
25e gradient
26, 28 area
30 curve
t depth
z wavelength representing the hue of color
T depth variation
L wavelength mixing

1.-10. (canceled)

11. A security element comprising:
a structured layer comprising a base surface and recesses recessed or protrusions elevated relative to the base surface, and
a reflector layer arranged on the structured layer,
wherein the recesses or protrusions are formed as color-generating nanostructures with respect to their dimensions along the base surface, their vertical extension perpendicular to the base surface and their arrangement on the base surface,
wherein the structured layer comprises a plurality of areas providing a colored motif or image, the areas forming pixels,
wherein in each of the several areas the vertical extension of the recesses or protrusions varies along a direction according to a function that does not have a constant value, so that in each of the several areas in top view a color which is produced by the variation of the vertical extension is a mixed color.

12. The security element according to claim 11, wherein at least some of the areas differ with regard to said function.

13. The security element according to claim 11, wherein the vertical extension of the recesses or protrusions increases or decreases along the direction according to a gradient.

14. The security element according to claim 11, wherein that the areas of the recesses or protrusions have the same dimensions along the base surface and/or arrangement on the base surface.

15. The security element according to claim 11, wherein the areas are each formed as elements of a microstructure, in particular as inclined mirror surfaces in which the base surface is inclined with respect to a base plane, at least a part of the areas differ from one another with regard to the inclination and/or shape of the mirror surface.

16. The security element according to claim 15, wherein the direction in each area follows a gradient of the elements of the microstructure, in particular of the mirror surface.

17. The security element according to claim 15, wherein the vertical extension increases or decreases with the height of the mirror surface above the base plane.

18. The security element according to claim 15, wherein the microstructure causes a bulging effect.

19. A method for manufacturing a security element, the method comprising:
creating a structured layer comprising a base surface and recesses recessed or protrusions elevated relative to the base surface, and
arranging a reflector layer on the structured layer,
wherein the recesses or protrusions are formed as a color-generating nanostructure with respect to their dimensions along the base surface, their vertical extension perpendicular to the base surface and their arrangement on the base surface,
wherein the structured layer is formed with a plurality of areas which provide a coloured motif or image, the areas forming pixels, and
wherein in each of the several areas the vertical extension of the recesses or protrusions along a direction varies according to a function that does not have a constant value, so that in each of the several areas in top view a color which is produced by the variation of the vertical extension is a mixed color.
